(19) United States
(12) Patent Application Publication
(10) Pub. No.: US 2006/0069574 A1
(43) Pub. Date: Mar. 30, 2006

(54) Selling system and selling method for pictures through internet and computer solftware thereof

(76) Inventor: Chul-sik Ok, Gyeonggi-do (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 10/534,958

(22) PCT Filed: Nov. 18, 2002
(86) PCT No.: PCT/KR02/02152

§ 371 Date: May 16, 2005

(51) Int. Cl. G06Q 99/00; G06Q 30/00

(52) U.S. Cl. 705/1; 705/26

(57) ABSTRACT

A picture selling system using the internet and selling method thereof are disclosed. According to the present invention, an artist, a picture purchaser, a picture selling agency, a picture provider and a web server of a picture selling site are connected one another through the internet network. The web server stores and manages pictures uploaded to a picture information database by the artist, or outputs the pictures stored at the picture information database according to the request of the purchaser in conjunction with the picture provider, or links it to other picture provider so that it can output the picture from the picture provider. The web server then converts the picture selected by the purchaser into a dedicated picture file so that the picture meets the requirement of the purchaser, and then transmits it to a picture selling agency nearest to the purchaser. The agency restores the dedicated picture file to produce a picture meeting the requirement of the purchaser and then supplies the produced picture to the purchaser. Therefore, all of the artist, the picture selling agency and the purchaser can trade pictures satisfactorily.

### TECHNICAL FIELD

The present invention relates to a picture selling technology using the internet, and more particularly, to a picture selling system using the internet, and selling method and selling program thereof, wherein an artist, a picture purchaser, a picture selling agency, a picture provider and a web server of a picture selling site are connected one another through the internet network, the web server stores and manages pictures that are uploaded to a picture information database by the artist, or outputs the picture stored at the picture information database to a purchaser's computer at the request of the purchaser in conjunction with the picture provider, or causes the pictures held by the picture provider to be outputted, the web server also converts a given picture of the outputted pictures, which the purchaser decided to purchase, into a dedicated electronic picture file meeting the requirements of the purchaser according to a dedicated program, and then transmits the picture file along with purchase information to a picture selling agency nearest to the purchaser from its picture information database or the picture provider, the picture selling agency then restores the dedicated picture file to produce a picture meeting the requirements of the purchaser and then supplies the produced picture to the purchaser.

### BACKGROUND ART

In general, if one wants to purchase a picture, the purchaser must directly buy a desired picture from the gallery at which the original work is exhibited if the work is copyrighted. On the contrary, if the picture is not copyrighted, the purchaser may purchase a printed copy of the original work.

Recently, as the internet technology is advanced, there is a trend that the number of the sites for selling a work of art on the internet or the sites for providing the work or art the copyright of which is expired without compensation is gradually increased. Under this environment, the purchaser may purchase a desired work of art from the site or download it from the site without compensation.

The above picture distribution method, however, has a problem that it could not satisfy the artist, the purchaser and the seller at all.

An artist gains benefits for one's sold work. Further, the artist's early work would have been sold at a relatively low price until the artist becomes famous. Even though the artist is famous now, it is not entitled to have a right to gain benefits for his/her past work.

Also, it is difficult for the purchaser to buy an artist's original work. Even though the purchaser buys a copy of the original work, there is no choice but to purchase a copy of a low quality not a high quality.

Further, a seller who runs a gallery for exhibiting a work or a picture selling agency may have many problems in maintaining and running the gallery or the picture selling agency due to surplus stock, distribution cost, damage of the work, the rental fee of the work, and the like. Also, the sellers are not provided with various pictures that may meet the requirements of the purchaser.

Meanwhile, a conventional picture selling method using the internet includes expanding and composing electronic picture files that were converted to be consistent with the resolution of the computer monitor. Due to this, this method has a problem that it could not produce a duplicated work having the same resolution to the original work. At this time, the electronic picture file can be duplicated infinitely through electronic devices such as the computers, like common text files.

### DISCLOSURE OF INVENTION

Accordingly, the present invention is directed to substantially obviate one or more problems due to limitations and disadvantages of the related art.

An object of the present invention is to provide a picture selling system using the internet, selling method and selling program thereof, wherein the original work held by an artist or a picture provider is converted into a dedicated electronic picture file and is then distributed through the internet network and electronic devices, whereby the artist can have a copyright to the original work, may allow copy and distribution of a digital duplication generated from the original work in order to gain benefits therefrom and can sell one's original work at a reasonable price depending on the frequency number of download of the duplication posted on the internet, the picture seller does not need to have a physical exhibition space for exhibiting various works and can exhibit many pictures of various kinds on the internet, and a purchaser can easily purchase a desired work meeting the purchaser's requirements.

Another object of the present invention is to provide a picture selling system using the internet, and selling method and selling program thereof, wherein the original work held by an artist or a picture provider is converted into a dedicated electronic picture file that can be restored more than once, a duplication having the same quality to the original work and meeting the requirements of a picture purchaser is produced from the converted dedicated electronic picture file and is then supplied to the picture purchaser, and the restored dedicated electronic picture file is deleted from a recording medium in which the dedicated electronic picture file is processed, whereby the artist can have a copyright to the original work, may allow copy and distribution of a digital duplication generated from the original work in order to gain benefits therefrom and can sell one's original work at a reasonable price depending on the frequency number of download of the duplication posted on the internet, the picture seller does not need to have a physical exhibition space for exhibiting various picture works and can exhibit many pictures of various kinds on the internet, and the purchaser can easily purchase a desired picture meeting the purchaser's requirements.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a picture selling system using the internet comprises a picture provider for providing pictures through the internet network, a picture purchaser for viewing the pictures exhibited on a given virtual gallery through the internet network and requesting purchase of a desired picture among the exhibited pictures, a picture mediation server connected to the internet network, for receiving the pictures from the picture provider to exhibit those pictures at the virtual gallery and converting the desired picture which the purchaser wants to buy into a dedicated electronic picture file, at the request of the picture purchaser, and a picture selling agency for receiving the dedicated electronic picture file through the internet network to restore the file to a picture requested by the picture purchaser, and for outputting the restored picture through a given printer and automatically deleting the dedicated electronic picture file at the same time.

In another aspect of the present invention, a picture selling method using the internet comprises the steps of by a web server that inputs pictures provided from a picture provider through the internet network and data related to the pictures, classifying these data to construct a picture information database, after the purchaser views the pictures provided from the picture information database, receiving a picture to be purchased by the purchaser among the viewed pictures and purchase information containing packing information thereof from the purchaser, according to purchase information of the purchaser, converting the picture wanted by the purchaser into a dedicated electronic picture file, and then transmitting the dedicated electronic picture file to a picture selling agency nearest to the purchaser through the internet network, and restoring the dedicated electronic picture file transmitted to the picture selling agency through the internet network to output the picture wanted by the purchaser, and automatically deleting the dedicated electronic picture file from the picture selling agency at the same time.

In still another aspect of the present invention, a picture selling program using the internet, which causes pictures provided by a picture provider to be exhibited at a virtual gallery and a picture selected by a picture purchaser, of the pictures exhibited at the virtual gallery to be outputted through a picture selling agency, through the internet network comprises a means for storing the pictures provided by the picture provider and data relating to the pictures, and exhibiting the pictures at the virtual gallery, a means for converting the picture which the purchaser wants to purchase, of the pictures exhibited at the virtual gallery, into a dedicated electronic picture file, a means for transmitting the dedicated electronic picture file and purchase information of the purchaser to a picture selling agency nearest to the purchaser, and a means for restoring the dedicated electronic picture file transmitted to the picture selling agency to output it through a given printer, and deleting the outputted dedicated electronic picture file.

It is to be understood that both the foregoing general description and the following detailed description of the present invention are exemplary and explanatory and are intended to provide further explanation of the invention as claimed.

### BRIEF DESCRIPTION OF THE DRAWINGS

Further objects and advantages of the invention can be more fully understood from the following detailed description taken in conjunction with the accompanying drawings in which:

FIG. 1 illustrates a structure of a picture selling system using the internet according to the present invention,

FIG. 2 is a flowchart for explaining the operation of the picture selling system according to the present invention,

FIG. 3 is a flowchart for explaining a method of constructing a picture information database,

FIG. 4 is a flowchart for explaining a method of purchasing a desired picture using the picture selling system according to the present invention,

FIG. 5 is a flowchart for explaining a method of outputting and delivering the picture, for which purchase request is made,

FIG. 6 illustrates an example of a member entry screen according to the present invention,

FIG. 7 illustrates an example of my gallery menu screen according to the present invention,

FIG. 8 illustrates a search screen according to the present invention, and

FIG. 9 illustrates a virtual gallery according to the present invention.

### BEST MODE FOR CARRYING OUT THE INVENTION

The present invention will now be described in detail in connection with preferred embodiments with reference to the accompanying drawings. For reference, like reference characters designate corresponding parts throughout several views.

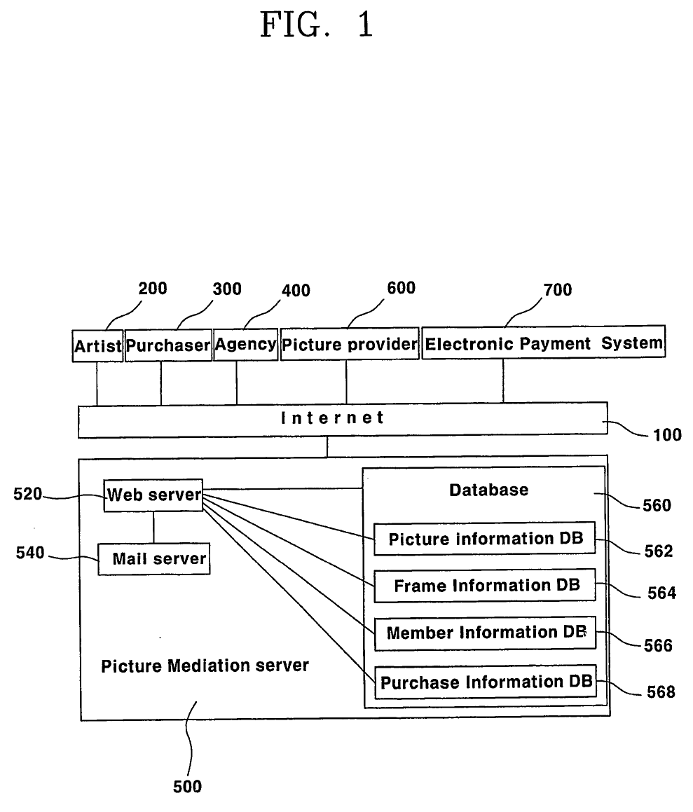

FIG. 1 illustrates a structure of a picture selling system using the internet according to the present invention.

The picture selling system comprises an artist 200 for uploading one's pictures through the internet network 100, a purchaser 300 who tries to purchase a desired picture through the internet network 100, an agency 400 for outputting and producing a picture wanted by the purchaser, a picture provider 600 for holding lots of pictures of various kinds, a picture mediation server 500 for transmitting the pictures received from the artist 200 or the pictures held by the picture provider 600 to the purchaser 300, through the internet network 100, and an electronic payment system 700 for authenticating the purchaser and settling a picture's price corresponding to the picture which the purchaser tries to purchase, through the internet network 100.

The picture mediation server 500 comprises a web server 520, a mail server 540 and a database 560.

If a client computer such as an artist, a purchaser, an agency, etc. is connected to the web server 520 through the internet network 100, the web server 520 sends its homepage to the client computer. Then, if the client computer selects a menu displayed on the homepage and then inputs data corresponding thereto, the web server executes given application programs and processes corresponding to them, and then transmits the execution result to the client computer. Also, the web server 520 has an address of the picture provider 600 linked to its web page, so that the purchaser can easily access the picture provider 600.

The mail server 540 is a server for transmitting the mail to a specified address. The mail server 540 transmits purchase information requested by the purchaser, to the address of the agent computer 400.

The database 560 comprises a picture information database 562, a frame information database 564, a member information database 566 and a purchase information database 568.

The picture information database 562 stores information on data such as the size, description, a write, creative year/month/date, announcement year/month/date, of the picture, and the like, and data such as the copyright, etc. The picture information database 562 further stores information on the royalty (rate per the number of use) depending on the use of the work, which is agreed between the artist and the seller in advance.

The frame database 564 stores information on the frame such as a material, size, design and kind of the frame that will pack the picture outputted from the picture selling agency's computer.

The member information database 566 stores information on the artist, the purchaser and the picture selling agency. Information on the artist includes personal information such as a name, an address, a telephone number, e-mail address, etc., and work-related information such as the number of the work, an award history, a trend of the work, and the like. Information on the purchaser includes personal information such as a name, an address, a telephone number, e-mail address, etc., which are used to deliver the work to the purchaser. Information on the picture selling agency includes information on geographical location, manager, holding equipments, etc.

The purchase information database 568 stores information on the picture, information on the selected frame, and information on the payment means, which are selected by the purchaser.

The picture provider 600 is a site connected to the internet network. It may be located locally or overseas.

A method of operating the picture selling system constructed above according to the present invention will be described in detail in conjunction with the drawings.

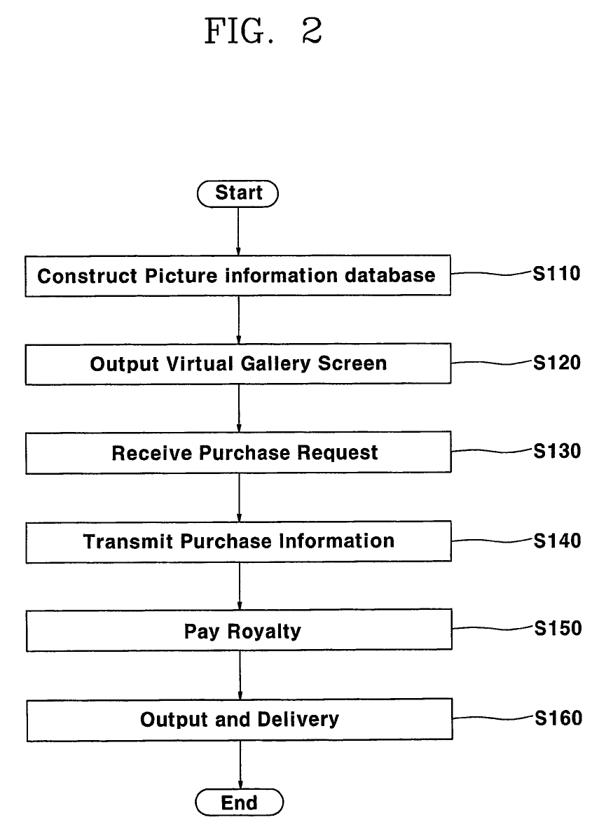

FIG. 2 is a flowchart for explaining the operation of the picture selling system according to the present invention.

An operator of the picture selling system constructs a picture information database in order to provide a picture selling service (Step S110). In a moment, the picture information database uploads a picture directly created by the artist to the picture selling system. Also, the picture information database 562 admits a new artist as a member and simultaneously provides a virtual gallery to the registered member with compensation or without compensation. It is preferred that the virtual gallery is constructed directly by the registered member. Further, in case of pictures the copyrights of which are expired, the operator of this system collects those pictures and stores them at the picture information database so that they can be freely traded. In addition, the picture information database may be constructed in conjunction with the site of the picture provider who holds lots of pictures of various kinds. The picture information database constructed above stores pictures by writer, country and genre.

After the picture information database 562 is constructed through the above processes, if the purchaser as a member registered in the picture information database requests viewing of a given picture stored at the picture information database, the picture information database displays a screen of the virtual gallery on the monitor of the purchaser's computer (Step S120).

If the purchaser sends a purchase request in order to buy a selected picture of the works exhibited at the virtual gallery, the web server receives the purchase request by the purchaser (Step S130). The purchase information database 568 then stores purchase condition and purchase information of the picture, which are selected by the purchaser.

Next, the web server confirms the payment method selected by the purchaser and whether the purchaser paid. After the wet server determines that the payment is successfully made, it edits the picture exhibited at the virtual gallery based on the purchase condition and then converts it into a dedicated electronic picture file format. Next, the web server transmits the converted file along with the purchase information to the agency's computer nearest to the purchaser (Step S140).

Meanwhile, after the web server transmits the purchase information and the converted picture to the purchaser, it pays the artist a prescribed royalty for the picture according to the royalty agreed with the artist in advance (Step S150).

The dedicated electronic picture file transmitted from the web server to the picture selling agency, is restored to a picture before a dedicated program installed at the picture selling agency's computer is automatically decoded and is then converted into the dedicated electronic picture file, simultaneously when transmission of the dedicated electronic picture file to the agency's computer is completed, and is then displayed on the monitor. At this time, the dedicated picture electronic film is transmitted from the web server to the agency's computer once, activated only through the dedicated program and then displayed on the monitor. After the displayed picture is outputted to the printer once, it is automatically deleted from the recording medium of the agency's computer. In other words, the dedicated electronic picture file is activated by the dedicated program only for the purpose of preventing edition or copy by other graphic programs.

The dedicated program is installed at the picture selling agency's computer. The program has functions of restoring the dedicated electronic picture file received through the internet network to display it on the monitor and deleting the file, and simple edition functions such as replacement of a letter style, change of the latter size, image composition, in the picture, etc.

On the contrary, the dedicated program does not have a function for opening the dedicated electronic picture file in its menu. Further, the dedicated program does not have a function of newly storing the dedicated electronic picture file but have a function of executing common graphic programs such as Photoshop®, etc. in case of common graphic images.

Meanwhile, the dedicated program automatically reports an error when the dedicated electronic picture file is not completely received due to external factors during reception from the web server. After the dedicated electronic picture file is fully received, the dedicated program executes the above processes.

As above, the dedicated electronic picture file activated by the dedicated program only, is converted from the picture held by the web server or the picture provider specified by the web server to a dedicated file format, before the dedicated electronic picture file is transmitted to the picture selling agency. The dedicated electronic picture file is then transmitted to the picture selling agency if the dedicated electronic picture file needs to be stored or at the request of a purchaser.

Therefore, the picture outputted to the printer through the above processes is put in frame and is then delivered to the purchaser (Step S160).

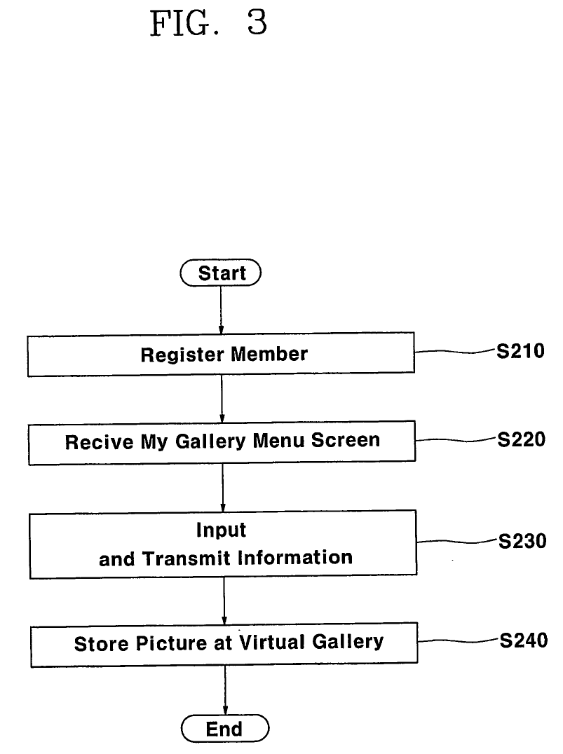

FIG. 3 is a flowchart for explaining in detail the steps of constructing the picture information database in FIG. 2.

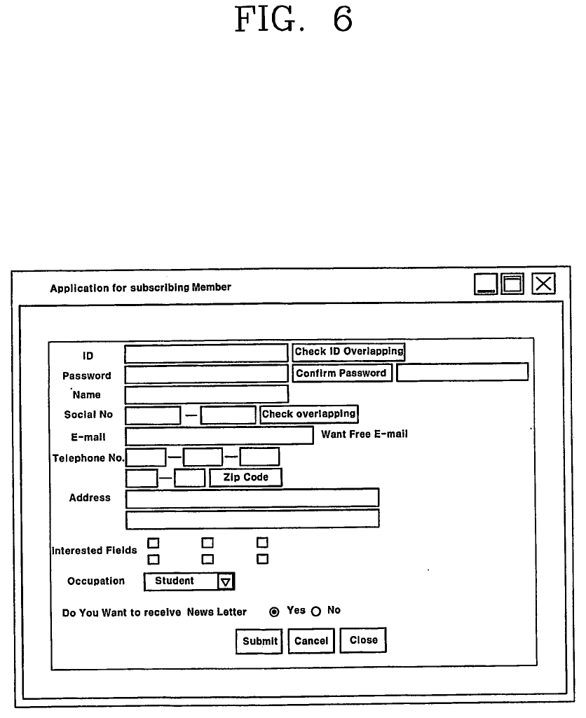

If the artist wants to upload one's work to the picture selling system, the artist accesses the web server of the picture selling site and then becomes a member through given membership registration screen, as shown in FIG. 6 (Step S210).

After the artist is allowed to be a member of the web server, the web server allocates a virtual gallery space to the artist. At this time, the use of the virtual gallery may be provided with compensation or without compensation when the artist exhibits one's works.

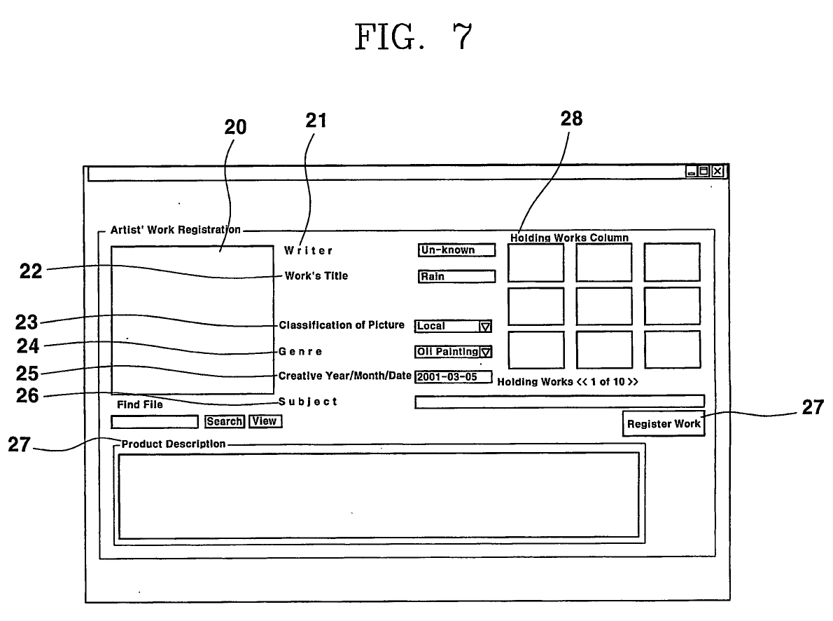

If the registered artist requests access to the web server in order to upload one's work to the virtual gallery, the web server authenticates the artist. Accordingly, if the artist who accesses the web server is determined to be a registered member, the web server sends my gallery menu screen to the artist' computer, as shown in FIG. 7 (Step S220). At this time, FIG. 7 illustrates an example of my gallery menu screen. My gallery menu screen includes a display window 20 for displaying an image of a work that is scanned and stored by the artist, an artist input window 21, a work title input window 22, a picture classification select window 23, a genre select window 24, a creative date input window 25, a subject input window 26 and a work description input window 27. Further, the my gallery menu screen may include a holding work column 28 from which the uploaded picture is outputted in a small thumbnail scheme, and a search window by which already registered work can be easily found, so that the artist can view the pictures that have been uploaded so far by oneself.

The artist who received the my gallery menu screen inputs information necessary for outputted input windows and then clicks a product registration button 29 on the my gallery menu screen to transmit information inputted to the input windows to the web server of the picture selling system (Step S230).

Thereafter, the picture selling system classifies information written in the my gallery menu and then stores classified information at the virtual galleries corresponding to the artists within the picture information database (Step S240). In a moment, if the artist scans one's pictures or photographs them using the digital camera and then uploads the pictures to the web server in a format of PSD, AI, BMP, JPG, TIF, etc., the web server formats the pictures into the dedicated electronic picture file format and then stores them, so that they can be executed in the dedicated program. The picture information database is thus constructed.

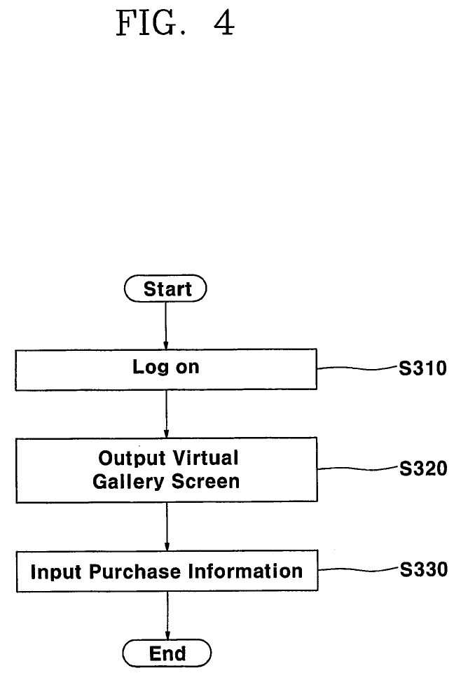

FIG. 4 is a flowchart for explaining a method of purchasing a desired picture through the picture selling system according to the present invention.

If one wants to buy a picture, the purchaser must access the web server of the picture selling system and then log on it (Step S310). At this time, if the purchaser is not a registered member, it is required that the purchaser be registered for the web server of the picture selling system through common membership registration procedure.

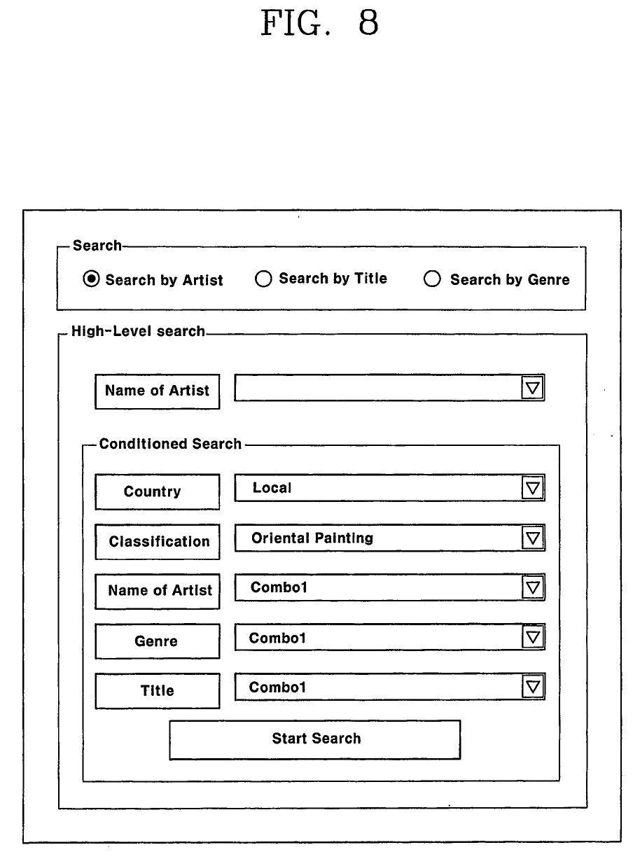

The purchaser who logged on the web server may access a desired gallery in order to see exhibited works, through a search screen by which the purchase could search directories classified by an artist or a subject or may search keywords, on the home page of the picture selling site, as shown in FIG. 8 (Step S320). At this time, FIG. 8 illustrates an example of the search screen. The search screen is divided into a general search part and a general search part. The general search part includes a search condition on which search by the artist, search by the title and search by the genre can be made. The high-level search part includes a search window through which one's name could be directly inputted and searched, and a condition search window such as a country, classification of pictures, a writer, a genre, a title, and the like.

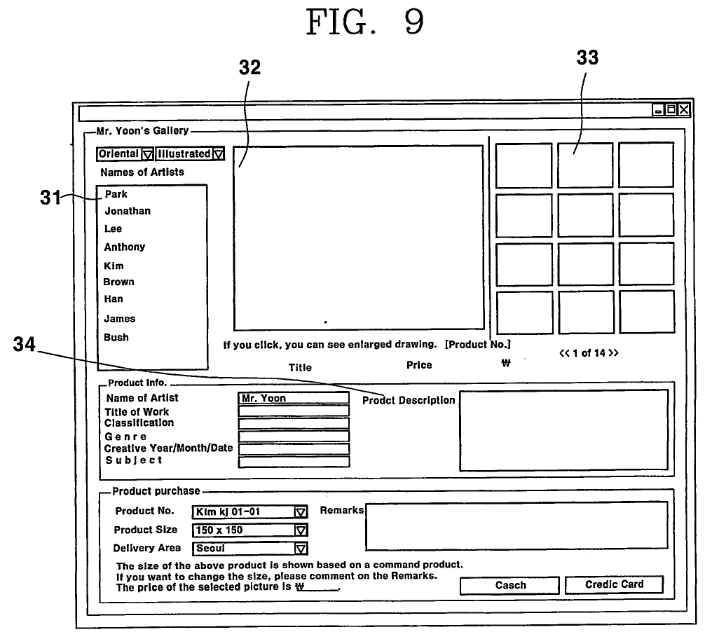

The gallery of the artist constitutes a three-dimensional virtual space in order for the purchaser to think that he/she views the pictures at the real gallery, as shown in FIG. 9. Accordingly, if the purchaser selects a wanted picture while viewing the gallery of the artist, not only the selected picture is displayed with it expanded fit to the full screen but also description thereof is displayed.

At this time, FIG. 9 illustrates the virtual gallery according to the present invention. The virtual gallery includes an artist select window 31 through which an artist, who registered for the picture selling system and had one's virtual gallery, may be selected, a thumbnail display window 33 for displaying the pictures inputted by the artist in a thumbnail mode, a picture display window 32 for displaying a selected picture of the pictures displayed on the thumbnail display window 33, and a work introduction window 34 for describing the picture displayed on the picture display window 32.

Therefore, the purchaser can select a desired picture of the pictures displayed on the monitor and then place an order. After the web server accepts the order, it outputs to the purchaser a purchase information screen including a select menu consisting of a price information column, a size selection column, a selection textile column, a frame selection column, a payment method column, etc. Next, the purchaser inputs information necessary for the purchase information displayed on the monitor and then transmits inputted information to the web server (Step S330).

Meanwhile, if the purchaser pays the picture price by cash or credit card using the electronic payment system 700, the web server transmits a receipt file to the purchaser on the internet so that the purchaser can confirm the paid expenses.

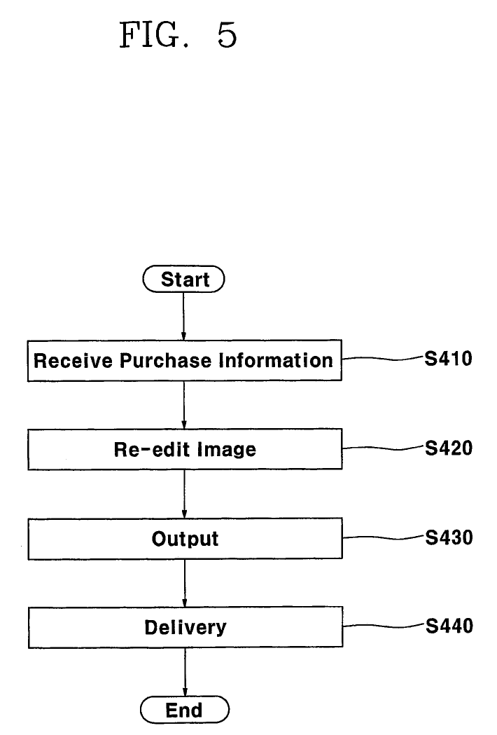

FIG. 5 is a flowchart for explaining a method of outputting and delivering the picture for which purchase request is made.

The web server receives purchase information from the purchaser. Next, the server transmits purchase information and a dedicated electronic picture file corresponding thereto to a picture selling agency nearest to the purchaser, through the internet network (Step S410).

Thereafter, the dedicated electronic picture file transmitted to the picture selling agency is automatically executed by the dedicated program installed at the picture selling agency's computer, and is then displayed on the monitor. At this time, a letter style and the size of the letter in the picture displayed on the monitor may be changed and images therein may be composed, by means of the dedicated program (Step S 420).

After the re-edition process, the picture having the same high quality to the original picture is printed using a high-resolution ink jet printer in the agency (Step S430). At this time, the textile on which the picture is printed may be materials such as canvas, textile, paper, etc. and selected at the request of the purchaser. Further, the picture outputted from the printer is fit into an assembled frame or a common frame, thus completing a finished product. The finished product is then delivered to the address of the purchaser (Step S440).

### INDUSTRIAL APPLICABILITY

As described above, according to the picture selling system using the internet and selling method thereof, the present invention can have new effects that it allows an artist to secure a virtual space on which one's work can be exhibited, gain benefits through selling of a duplicate of the original work not the original work, and sell the original work at a reasonable price calculated by the number of download. Further, the present invention has advantageous effects that it allows a purchaser to view works of various kinds by several artists, which are exhibited at the virtual gallery, without visiting the real gallery for exhibiting the works, and easily purchase a desired work of a desired shape. Also, the present invention has outstanding effects that it allows a seller to do without an exhibition space for containing many works, and get out of burdens such as surplus stock, distribution cost, damage of the works, the rental fee of the works, and the like.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A picture selling system using the internet, comprising:
a picture provider for providing pictures through the internet network;
a picture purchaser for viewing the pictures exhibited at a given virtual gallery through the internet network and requesting purchase of a desired picture among the exhibited pictures;
a picture mediation server connected to the internet network, for receiving the pictures from the picture provider to exhibit those pictures at the virtual gallery and converting the desired picture which the purchaser wants to buy into a dedicated electronic picture file, at the request of the picture purchaser; and
a picture selling agency for receiving the dedicated electronic picture file through the internet network to restore the file to a picture requested by the picture purchaser, and for outputting the restored picture through a given printer and automatically deleting the dedicated electronic picture file at the same time.

2. The picture selling system as claimed in claim 1, wherein the picture provider is an artist who paints the pictures or a second picture mediation server for storing pictures of various kinds.

3. The picture selling system as claimed in claim 1 or 2, wherein the picture mediation server comprises:
a picture information database for storing the pictures received from the picture provider and data on the pictures;
a frame information database for storing information on the size, kind and material of the frame for packing the desired picture of the purchaser;
a member information database for storing information on the picture provider, the picture purchaser and the picture selling agency;
a purchase information database for storing purchase information of the purchaser for a picture which the purchase makes purchase request of the picture;
a web server for converting a picture corresponding to purchase information into the dedicated electronic picture file and entirely controlling respective constitution elements of the system; and
a mail server for transmitting the purchase information and the dedicated electronic picture file to the picture selling agency.

4. The picture selling system as claimed in claim 3, wherein the picture information database further includes information on the royalty of the picture, which is agreed with the artist in advance, depending on the frequency number where the picture of the artist is transmitted.

5. The picture selling system as claimed in claim 2, wherein the picture provider further comprises a second picture mediation server for storing pictures of various kinds.

6. The picture selling system as claimed in claim 5, wherein the picture mediation server connects the second picture mediation server to its web site in agreement with the mediation server in advance, and wherein if the purchaser requests a picture included in the second picture mediation server, the picture mediation server converts the picture requested by the purchaser into the dedicated electronic picture file and then directly sends the picture from the second picture server to the picture selling agency.

7. The picture selling system as claimed in claim 1, wherein the picture mediation server comprises a payment system for confirming receipt of money corresponding to the picture which the picture purchaser selected.

8. A picture selling method using the internet, comprising the steps of:
by a web server that inputs pictures provided from a picture provider through the internet network and data related to the pictures, classifying these data to construct a picture information database;
after the purchaser views the pictures provided from the picture information database, receiving a picture to be purchased by the purchaser among the viewed pictures and purchase information containing packing information thereof from the purchaser;
according to purchase information of the purchaser, converting the picture wanted by the purchaser into a dedicated electronic picture file, and then transmitting the dedicated electronic picture file to a picture selling agency nearest to the purchaser through the internet network; and
restoring the dedicated electronic picture file transmitted to the picture selling agency through the internet network to output the picture wanted by the purchaser, and automatically deleting the dedicated electronic picture file from the picture selling agency at the same time.

9. The picture selling method as claimed in claim 8, wherein the step of constructing the picture information database comprises the steps of:
by the picture provider, registering the web server as a member;
by the picture provider, logging on the web server;
allocating a virtual gallery space for exhibiting the pictures provided by the picture provider;
requesting, to the picture provider, information necessary to register the pictures to be exhibited at the virtual gallery space; and
receiving information on the picture provider, as requested, and then storing it at the picture information database.

10. The picture selling method as claimed in claim 9, further comprising the step of storing the royalty that was agreed with the picture provider in advance, depending on the frequency number where the pictures provided by the picture provider are used.

11. The picture selling method as claimed in claim 10, further comprising the step of paying a given royalty to the picture provider, depending on the frequency number where a corresponding picture is transmitted referring to the picture information database.

12. The picture selling method as claimed in claim 8, wherein the deletion step comprises the step of edition including change of a letter style and a letter size or composition with other images in the restored picture.

13. The picture selling method as claimed in claim 8, wherein the transmission step comprises the step of confirming whether money corresponding to the picture which the purchaser selected has been received.

14. A picture selling program using the internet, which causes pictures provided by a picture provider to be exhibited at a virtual gallery and a picture selected by a picture purchaser, of the pictures exhibited at the virtual gallery to be outputted through a picture selling agency, through the internet network comprising:
a means for storing the pictures provided by the picture provider and data relating to the pictures, and exhibiting the pictures at the virtual gallery;
a means for converting the picture which the purchaser wants to purchase, of the pictures exhibited at the virtual gallery, into a dedicated electronic picture file;
a means for transmitting the dedicated electronic picture file and purchase information of the purchaser to a picture selling agency nearest to the purchaser; and
a means for restoring the dedicated electronic picture file transmitted to the picture selling agency to output it through a given printer, and deleting the outputted dedicated electronic picture file.

15. The picture selling program as claimed in claim 14, wherein the exhibition means comprises:
a means for registering the picture provider as a member and authenticating the registered member;
a means for storing the pictures provided by a picture provider registered as a member and allocating the stored pictures to the virtual gallery for exhibition;
a means for making requests for picture information to the picture provider in order to input pictures to be exhibited at the allocated virtual gallery space;
a means for deciding the royalty of the picture based on the frequency number where the picture is transmitted, together with the picture provider;
a means for storing picture purchase information of the picture purchaser; and
a means for storing packing information of the picture to be purchased according to purchase information.

16. The picture selling program as claimed in claim 14, further comprising a means for confirming receipt of money corresponding to the picture which the purchaser wanted to buy.

17. The picture selling program as claimed in claim 14, wherein the deletion means comprises:
a means for receiving the dedicated electronic picture file and purchase information;
a means for restoring the dedicated electronic picture file to display a picture wanted by the purchaser on a given monitor; and
a means for outputting the picture based on purchase information.

18. The picture selling program as claimed in claim 17, further comprising a means for replacing a letter style, changing the size of the letter style and composing images in the displayed picture.
